(19) United States
(12) Patent Application Publication
(10) Pub. No.: US 2026/0355039 A1
(43) Pub. Date: Nov. 12, 2026

(54) REHABILITATION ROBOT

(71) Applicant: EGZOTECH SP. Z.O.O., Gliwice (PL)

(72) Inventors: Michal MIKULSKI, Gliwice (PL); Marcel SMOLINSKI, Gliwice (PL); Pawel SOJA, Gliwice (PL); Anna ROKSELA, Gliwice (PL); Anna POSWIATA, Gliwice (PL); Dominika KOZAK, Gliwice (PL); Jacek SOLTYS, Gliwice (PL)

(21) Appl. No.: 19/515,490

(22) PCT Filed: Aug. 8, 2024
(86) PCT No.: PCT/PL2024/000043

§ 371 Date: Mar. 1, 2026

(30) Foreign Application Priority Data
Aug. 30, 2023 (PL) P.445950

(51) Int. Cl. A61H 1/02

(52) U.S. Cl. CPC A61H 1/0274; A61H 2201/10; A61H 2201/1659; A61H 2201/501; A61H 2201/5043; A61H 2230/605

(57) ABSTRACT

A rehabilitation robot controlled by EMG signals, primarily for home use. A rehabilitation robot comprising a control device, a base, a housing containing an actuator driving the rotation of the arm mount, an arm, and at least two electromyogram (EMG) sensor electrodes, a screen on a bracket for displaying the device status and its control, characterized in that the base of the robot is flat, and in the base along the axis of the robot, on the side of the arm mount, there is a substantially horizontal opening for mounting clamps or dedicated weights where the housing has the form of a substantially flattened sphere and is rotatably connected to the base by means of side brackets in such a way that the housing can rotate 90° from a perpendicular position of the arm mount relative to the base to a parallel position.

The subject of the invention is a rehabilitation robot controlled by EMG signals, primarily for home use.

There are known solutions for rehabilitation 1 robots controlled by electromyogram.

A device for rehabilitation is known from the patent description P402465. The subject of the invention is a device for the rehabilitation of people, especially with paralysis of the peripheral nervous system. A rehabilitation device consisting of a control device, a base, an arm attached to a height-adjustable column containing an actuator driving the movement of the arm and at least two electromyogram (EMG) sensor electrodes according to the invention, characterized in that the actuator allows the arm to be moved within an angular range of 120°, and the EMG signal from the sensor connected to the patient's muscle or muscles is transmitted to the engine control module network and via radio or cable link to the remote control device.

From the American patent description No. US 2006/0253052, there is a method of rehabilitation of patients with complete or partial paralysis of the peripheral nervous system, manifested by reduced muscle tone or even muscle atrophy, where feedback is used between the signals seen and/or heard by the patient and the intensity of the graphs. the patient's electromyography when trying to move individual muscles. The method is intended primarily for patients with significant disabilities as an alternative to therapy using the AMES method.

US 2004/0106881 also discloses a powered device worn by a patient around the elbow or other joint that detects relatively low signals generated by the patient from the spinal cord or other mechanically damaged nerves around the joint. The device moves in response to the received signals, helping the patient make the appropriate movement of a given joint.

From the US patent description No. U.S. Pat. No. 5,722,420, a rehabilitation method is known that uses a closed loop of force regulation based on EMG signals from a selected muscle. This method relies on a master traction controller that uses the high signal-to-noise ratio of the EMG, then scans and converts it into sygnały understandable for computer programs, while self-correcting in real time the actuation force, using biofeedback control via visual or audible alarms. The main point of this solution is its auto-adjustment, which adjusts the traction forces to the EMG signals detected in real time.

There are known solutions for electrostimulation of muscles to accelerate their rehabilitation.

From the patent description U.S. Pat. No. 10,682,543 B1 , a lower limb rehabilitation device for passive, active and resistive range of motion and stretching is known, consisting of a thigh support connector connected to the base by a connector; a leg connector that is configured to support the user's leg and is connected to the thigh support connector, and a foot plate that is configured to support the user's foot and is connected to the leg connector, wherein the foot plate and connector are configured to move along said base in response to a force provided by the user in a first direction and are configured to move along the base in response to a force provided by the user in a second direction, the device being configured to apply resistance that is substantially consistent with the connector as it moves he along said base in a first direction.

A significant technical problem in known solutions is the size of the rehabilitation device, which limits the possibility of using the devices at home. Additionally, the size of the devices limits the functionality of the device and its ability to rehabilitate specific joints or muscles. Extending the device setting options and reducing its size compared to known solutions not only allows rehabilitation to be used in more difficult local conditions, including home use, but also expands the range of exercises that can be performed using the device.

A rehabilitation robot according to the invention comprising control devices, a base, a housing containing an actuator driving the arm mounting movement and at least two electromyogram (EMG) sensor electrodes, a screen on the bracket for displaying the device status and its control, characterized in that the base of the robot is flat, and in the base along the axis of the robot, on the side of the arm mount, there is a substantially horizontal opening for mounting clamps or dedicated weights where the housing has the form of a substantially flattened sphere and is rotatably connected to the base by means of side brackets in such a way that the housing can rotate 90° from a perpendicular position of the arm mount relative to the base to a parallel position.

Preferably, the arm mounting is connected to the actuator and control system without contact with the housing using a non-contact seal.

Alternatively, the robot is equipped with an electrostimulation system.

Alternatively, the robot includes a communication system enabling cooperation with external electrostimulation devices.

The solution used involves enclosing the drive of the exercise arm or other end in a small, rotating housing and separating the base from the robot mounting system, allowing it to be widely used in various conditions. It is possible to use clamps of various sizes in the form of a c-shaped angle where one arm is inserted into the hole in the robot's base and the other covers the table top to which the robot is clamped. The use of interchangeable mounting systems allows for secure mounting of the robot to various flat surfaces, as well as, for example, to angles protruding from walls—which allows the robot to be mounted in different positions at different heights, which significantly expands the functional capabilities of the robot by allowing it to be used in a wide range of rehabilitation exercises.

Moreover, in place of the robot mounting clamp, a weight can be inserted to stabilize the robot without the need to permanently mount it to a base or wall. The interchangeability of the clamps mounted to the base also allows the robot to be placed in a dedicated base containing, for example, wheels enabling easy movement of the robot.

The drawings below show examples of embodiments of the invention where

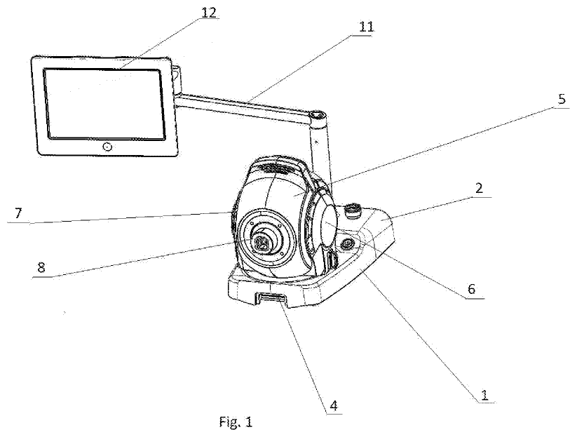

FIG. 1 shows an isometric view of the robot

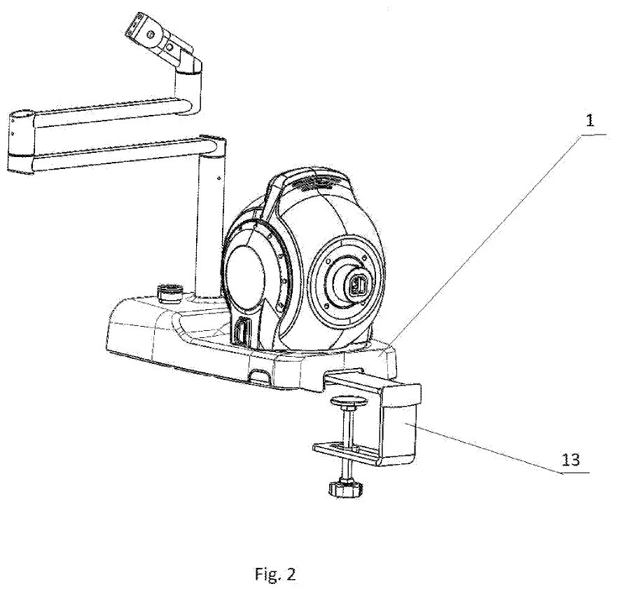

FIG. 2 shows an isometric view of the robot with the clamp 13 inserted into the hole in the base.

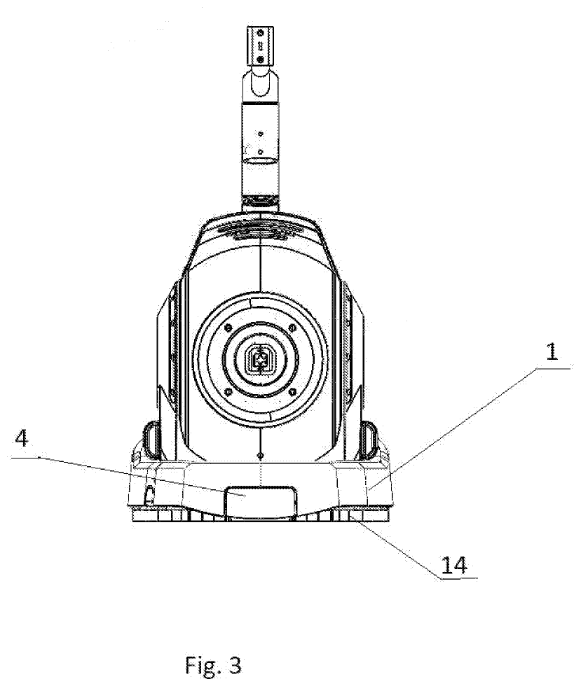

FIG. 3 shows a robot with a weight 14 installed instead of a clamp.

The rehabilitation robot 2 includes control devices, a base 1, a housing 5 containing an actuator driving the movement of the arm attachment 8, and at least two electromyogram (EMG) sensor electrodes, a screen 12 on the boom 11 for displaying the status of the device and its control. The base 1 of the robot is flat and in the base, in the axis of the robot 2, on the side of the arm 3, there is a hole 4 for mounting clamps or loads. The casing 5 is connected to the base 1 by means of side handles 6,7 in such a way that it is possible to rotate the casing by 90 ° from the perpendicular position of mounting the arm 8 in relation to the base 1 to a parallel position upwards. The arm mounting 8 is connected to the actuator and the control system without contact with the housing 5 using a non-contact seal. The robot is equipped with an electrostimulation system. The robot may contain a communication system enabling cooperation with external electrostimulation devices.

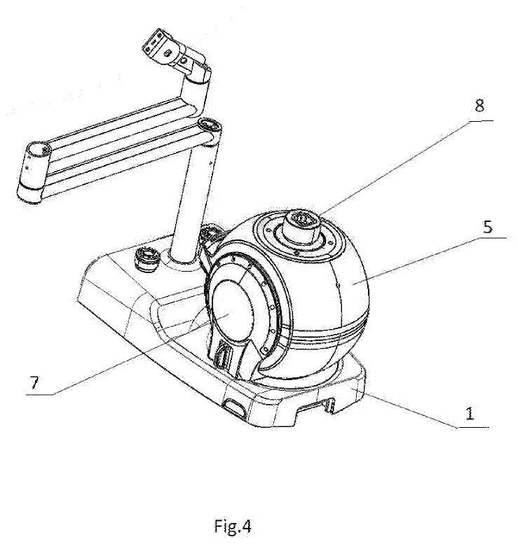

FIG. 4 shows the housing 5 rotated 90 ° upwards relative to the base 1.

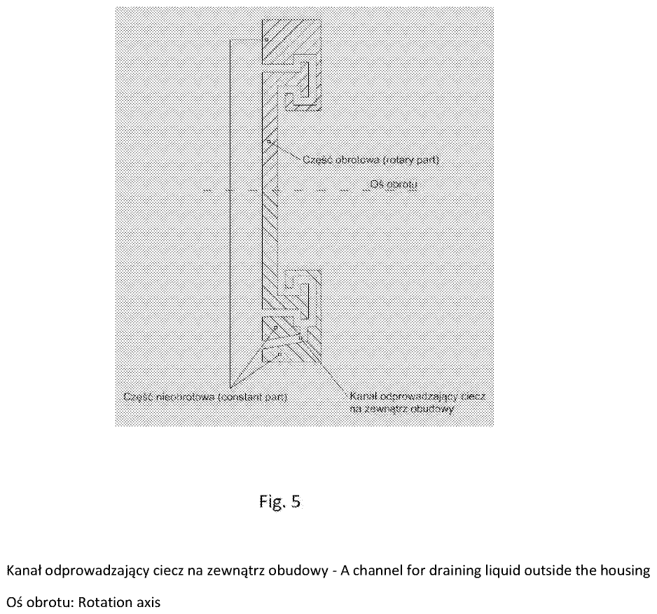

FIG. 5 shows a cross-section through the arm mounting seal 10 enabling contactless connection of the arm with exercise tips to the drive and measurement system without disturbing the reading of measurements from the arm resulting from the impact of the seal or working resistance on the housing.

The given embodiment does not exhaust the possibilities of using the invention

1. A rehabilitation robot comprising a control device, a base, a housing containing an actuator driving the rotation of the arm mount, an arm, and at least two electromyogram (EMG) sensor electrodes, a screen on a bracket for displaying the device status and its control, characterized in that the base (1) of the robot (2) is flat, and in the base (1) along the axis of the robot (2), on the side of the arm mount (3), there is a substantially horizontal opening (4) for mounting clamps or dedicated weights where the housing has the form of a substantially flattened sphere (5) and is rotatably connected to the base (1) by means of side brackets (6,7) in such a way that the housing (5) can rotate 90° from a perpendicular position of the arm mount (8) relative to the base (1) to a parallel position.

2. The robot according to claim 1 characterized in that the arm mount (8) is connected to the actuator and control system without contact with the housing (5) using a contactless seal (10).

3. The robot according to claim 1 characterized in that the robot is equipped with an electrostimulation system.

4. The robot according to claim 1 characterized in that it includes a communication system allowing cooperation with external electrostimulation devices.
